(19) United States
(12) Patent Application Publication
(10) Pub. No.: US 2026/0046014 A1
(43) Pub. Date: Feb. 12, 2026

(54) IDENTIFICATION AND AUTHORIZATION FOR A REPEATER IN A WIRELESS NETWORK

(71) Applicant: Apple Inc., Cupertino, CA (US)

(72) Inventors: Zhibin Wu, Los Altos, CA (US); Alexander Sirotkin, Hod Hasharon (IS); Haijing Hu, Los Gatos, CA (US); Ralf Rossbach, Munich (DE)

(21) Appl. No.: 19/101,967

(22) PCT Filed: Aug. 10, 2023
(86) PCT No.: PCT/US2023/029966

§ 371 Date: Feb. 7, 2025

Related U.S. Application Data
(60) Provisional application No. 63/396,602, filed on Aug. 10, 2022.

(51) Int. Cl. H04B 7/155; H04W 72/232; H04W 74/0833

(52) U.S. Cl. CPC H04B 7/155; H04W 72/232; H04W 74/0833

(57) ABSTRACT

The present disclosure relates to identification and authorization for a repeater in a wireless network. The repeater may transmit a random access request message to a base station, and receive a temporary ID for addressing the repeater from the base station, wherein the temporary ID is allocated by the base station in response to the random access request message. With use of the temporary ID of the repeater, the repeater can be identified during a random access procedure, and side control information for controlling the repeater can be correctly transmitted to the repeater from the base station.

### REFERENCE TO RELATED APPLICATIONS

This Application claims the benefit of U.S. Provisional Application No. 63/396,602, filed on Aug. 10, 2022, the contents of which are hereby incorporated by reference in their entirety

### TECHNICAL FIELD

This application relates generally to wireless communication systems, including identification and authorization for a repeater in wireless communication systems.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

In order to increase a coverage of a base station and/or improve communication quality between a UE and a base station, a repeater that can amplify and forward wireless signal is receiving more and more attention to be introduced into a wireless network such as a NR network. Such a repeater can be controlled by the network such as the base station to change its operational parameters, states and so on, so it can also be called as a network-controlled repeater (NCR).

There are some assumptions for the network-controlled repeater. For example, the repeater is usually an inband RF repeaters used for extension of network coverage on FR1 and FR2 bands, which means a deployed NCR and its serving base station have matching frequency bands. The repeater is a single hop stationary repeater, and it is deployed by a network operator or a user in order to improve coverage. At most one repeater can be used by a UE to reach a base station or by a base station to reach a UE. The repeater is transparent to the UE, so the UE cannot be aware of the existence of the repeater. Since the repeater is between the UE and the base station (for example a gNB in NR), the repeater can maintain a gNB-repeater link and a repeater-UE link simultaneously. Cost efficiency is a key consideration point for a network-controller repeater.

Several aspects of this network-controlled repeater need to be controlled by network which includes assumption of maximum transmission power, how to use L1/L2 signaling (including its configuration) to carry such information, and so on. Such information may be called as side control information. There is a control link protocol for side control to control the repeaters. For example, there could be three options for the NCR to obtain the necessary NCR configuration to receive L1/L2 signaling of side control information. Option one is to receive the necessary NCR configuration from a gNB by Radio Resource Control (RRC). In such a case, the gNB and the NCR should have the full protocol stack. Option two is to receive the necessary NCR information from Operation Administration and Maintenance (OAM) which may be a network entity or a device operated by a technical staff or to have the necessary NCR information to be hard-coded in both the gNB and the repeater. In such a case, the gNB and the repeater may have consistent information that is input to them by a technical staff or a network entity. OAM option relies on that the gNB and the repeater are in synchronization with the OAM record/config, and how the repeater and the gNB retrieve and update OAM records is out of the scope of 3GPP. Option three is to make the necessary NCR configuration partially configured by RRC and partially configured by OAM or being hard-coded. In such a case, the NCR configuration may be input to the gNB by a technical staff, and the gNB may transmit the NCR configuration to the NCR by an air interface between the gNB and the NCR.

There are some other aspects of NCR management, such as identification and authorization of the network-controlled repeaters. Since the NCR is a new network entity that may be introduced into the NR network, there is no well-known identification approach for the NCR, and further there is no well-known authorization approach for the NCR.

### SUMMARY

According to one aspect of the present disclosure, there is provided a repeater. The repeater may comprise: at least one antenna for performing wireless communications; a radio coupled to the at least one antenna; and a processor coupled to the radio and configured to cause the repeater to transmit a random access request message to a base station, and receive a temporary ID for addressing the repeater from the base station, wherein the temporary ID is allocated by the base station in response to the random access request message.

According to another aspect of the present disclosure, there is provided an apparatus for operating a repeater. The apparatus may comprise a processor configured to cause the repeater to: transmit a random access request message to a base station; and receive a temporary ID for addressing the repeater from the base station, wherein the temporary ID is allocated by the base station in response to the random access request message.

According to a further aspect of the present disclosure, there is provided a method performed by a repeater. The method may comprise: transmitting a random access request message to a base station; and receiving a temporary ID for addressing the repeater from the base station, wherein the temporary ID is allocated by the base station in response to the random access request message.

According to a further aspect of the present disclosure, there is provided a base station. The base station may comprise: at least one antenna for performing wireless communications; a radio coupled to the at least one antenna; and a processor coupled to the radio and configured to cause the base station to receive a random access request message from a repeater, allocate a temporary ID for addressing the repeater in response to the random access request message, and transmit the temporary ID to the repeater.

According to a further aspect of the present disclosure, there is provided an apparatus for operating a base station. The apparatus may comprise a processor configured to cause the repeater to: receive a random access request message from a repeater; allocate a temporary ID for addressing the repeater in response to the random access request message; and transmit the temporary ID to the repeater.

According to a further aspect of the present disclosure, there is provided a method performed by a base station. The method may comprise: receiving a random access request message from a repeater; allocating a temporary ID for addressing the repeater in response to the random access request message; and transmitting the temporary ID to the repeater.

According to a further aspect of the present disclosure, there is provided a non-transitory computer-readable memory medium storing program instructions, where the program instructions, when executed by a computer system, cause the computer system to perform any of the above methods.

According to a further aspect of the present disclosure, there is provided a computer program product, comprising program instructions which, when executed by a computer, cause the computer to perform any of the above methods.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system including a repeater, according to embodiments disclosed herein.

FIG. 2 illustrates a system for performing signaling between a repeater and a network device such as a base station, according to embodiments disclosed herein.

FIG. 3 illustrates an example communication architecture among a UE, a repeater and a base station.

FIG. 4A illustrates a flow chart of a method for identifying a repeater, according to embodiments disclosed herein.

FIG. 4B illustrates a flow chart of a method performed by a repeater, according to embodiments disclosed herein.

FIG. 4C illustrates a flow chart of a method performed by a base station, according to embodiments disclosed herein

FIG. 5 illustrates a flow chart of a method for identifying and authorizing a repeater, according to embodiments disclosed herein.

FIG. 6 illustrates a flow chart of another method for identifying and authorizing a repeater, according to embodiments disclosed herein.

FIG. 7 illustrates a flow chart of a further method for identifying and authorizing a repeater, according to embodiments disclosed herein.

### DETAILED DESCRIPTION

Various embodiments are described with regard to a repeater. However, reference to a repeater is merely provided for illustrative purposes. The example embodiments may be utilized with any electronic component that may establish a connection to a network and a UE and is configured with the hardware, software, and/or firmware to exchange information and data with the network and between the network and the UE. Therefore, the repeater as described herein is used to represent any appropriate electronic component.

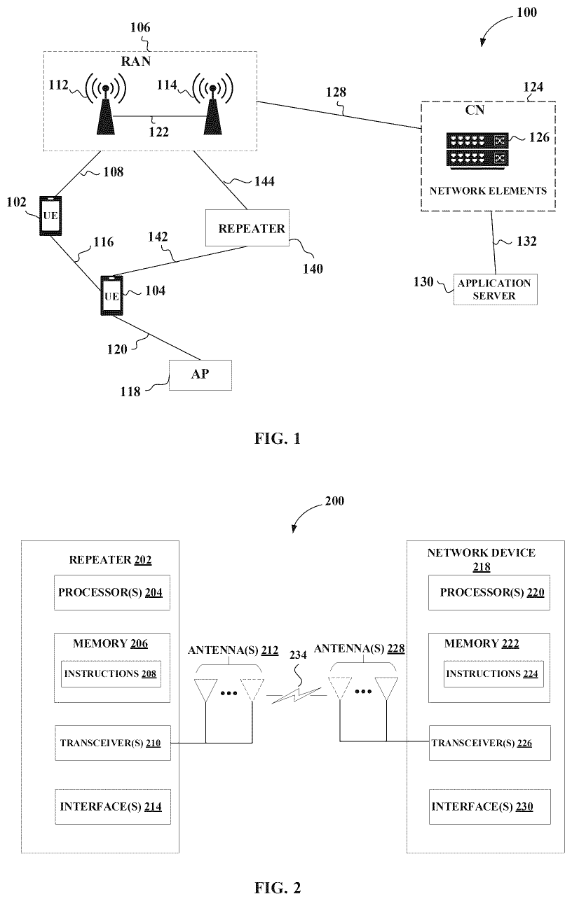

FIG. 1 illustrates an example architecture of a wireless communication system 100 including a repeater 140, according to embodiments disclosed herein. The following description is provided for an example wireless communication system 100 that operates in conjunction with the LTE system standards and/or 5G or NR system standards as provided by 3GPP technical specifications.

As shown in FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 utilizes connection (or channel) 108 with the RAN 106, which comprises a physical communications interface. The UE 104 utilizes connection (or channel) 142 with the repeater 140, and the repeater 140 utilizes connection (or channel) 144 with the RAN 106, so the UE 104 can indirectly communicate with the RAN 106 via the repeater 140 that may amplify and forward the transmission signal. Both the connection 142 and the connection 144 comprise a physical communications interface. The RAN 106 can include one or more base stations, such as base station 112 and base station 114, that enable the connection 108 and connection 144.

In this example, the connection 108 and connection 144 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

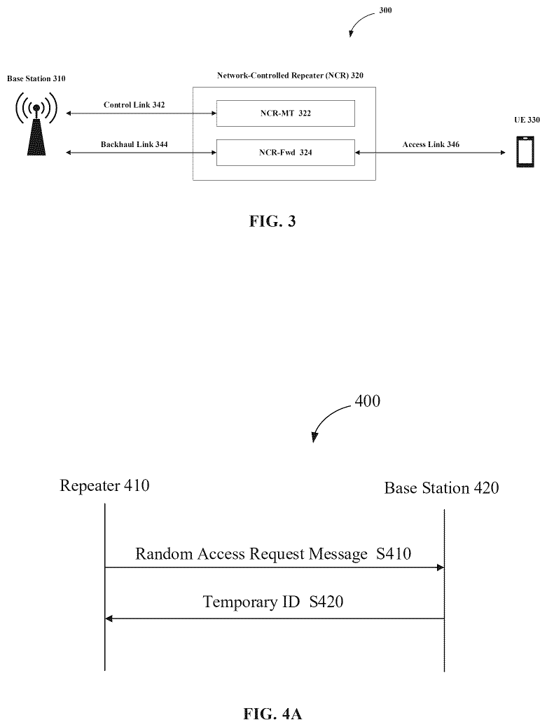

FIG. 2 illustrates a system 200 for performing signaling 234 between a repeater 202 and a network device 218, according to embodiments disclosed herein. The system 200 may be a portion of a wireless communications system as herein described. The repeater 202 may be called as a network-controlled repeater since it may receive control information from the network to execute corresponding operations. The network device 218 may be, for example, a base station (e.g., an eNB or a gNB) of a wireless communication system.

The repeater 202 may include one or more processor(s) 204. The processor(s) 204 may execute instructions such that various operations of the repeater 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The repeater 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The repeater 202 may include one or more transceiver(s) 210 that may include radio frequency (RF) transmitter and/or receiver circuitry that use the antenna(s) 212 of the repeater 202 to facilitate signaling (e.g., the signaling 234) to and/or from the repeater 202 with other devices (e.g., the network device 218) according to corresponding RATs.

The repeater 202 may include one or more antenna(s) 212 (e.g., one, two, four, or more). For embodiments with multiple antenna(s) 212, the repeater 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the repeater 202 may be accomplished according to precoding (or digital beamforming) that is applied at the repeater 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the repeater 202 may implement analog beamforming techniques, whereby phases of the signals sent by the antenna(s) 212 are relatively adjusted such that the (joint) transmission of the antenna(s) 212 can be directed (this is sometimes referred to as beam steering).

The repeater 202 may include one or more interface(s) 214. The interface(s) 214 may be used to provide input to or output from the repeater 202. For example, a repeater 202 may include interface(s) 214 such as microphones, speakers, a touchscreen, buttons, and the like in order to allow for input and/or output to the repeater by a user to for example configure or debug the repeater. Other interfaces of such a repeater may be made up of transmitters, receivers, and other circuitry (e.g., other than the transceiver(s) 210/antenna(s) 212 already described) that allow for communication between the repeater and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the repeater 202 or a UE that can be directly communicated with) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

Even though FIG. 2 illustrates the repeater 202 and network device 218, it is also applicable to a repeater and a UE, or to a UE and a network device, with some necessary modification persons skilled in the art are familiar with.

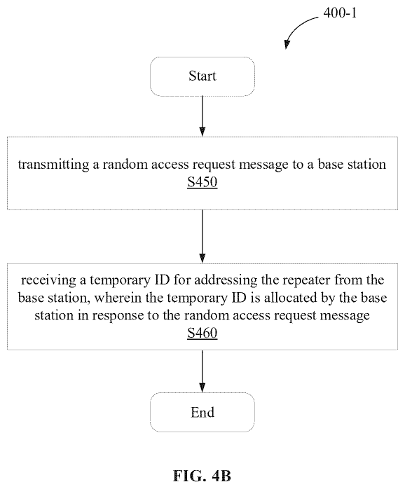

FIG. 3 schematically illustrates an example communication architecture 300 among a UE 330, a repeater and a base station. In FIG. 3, the base station is for example a gNB, the repeater is shown as an NCR, and the NCR 320 and the UE 330 access to the gNB 310 using a 5G or NR radio access technology. Please be noted that the repeater herein can also be called as an NCR, because it can be controlled by the network such as a gNB or a core network (CN). Even though the gNB is used as an example of the base station, the base station can be of other kinds, such as Node-B and eNB. The radio access technology adopted in the access network may be other technologies, such as EDGE RAT, LTE RAT and other 3GPP RAT.

The NCR 320 includes two modules, NCR-MT (Mobile termination) 322 and NCR-Fwd (Forwarding) 324. The NCR-MT 322 is used to communicate with the gNB 310 via a control link 342 to obtain information used to configure the NCR 320 and control operations of the NCR 320. The NCR-Fwd 324 is used to forward signal between the UE 330 and the gNB 310 via a backhaul link 344 and an access link 346.

Each of the NCR-MT 322 and NCR-Fwd 324 may be implemented via hardware, software, or combinations thereof. For example, each of the NCR-MT 322 and NCR-Fwd 324 may be implemented as a processor, circuit, and/or instructions 208 stored in the memory 206 and executed by the processor(s) 204 as shown in FIG. 2. In some examples, each of the NCR-MT 322 and NCR-Fwd 324 may be integrated within the processor(s) 204 and/or the transceiver(s) 210. For example, each of the NCR-MT 322 and NCR-Fwd 324 may be implemented by a combination of software components (e.g., executed by a DSP or a general processor) and hardware components (e.g., logic gates and circuitry) within the processor(s) 204 or the transceiver(s) 210 as shown in FIG. 2. The NCR-MT 322 and NCR-Fwd 324 may be implemented in different processors or memories, or they may be implemented in the same processor or memory. Even though FIG. 3 depicts the NCR-MT 322 and NCR-Fwd 324 as two modules, they may be in the same module. The separation of the NCR-MT 322 and NCR-Fwd 324 in FIG. 3 may be based on their functions or operations.

the NCR-MT 322 may receive side control information from the gNB 310 via the control link 342, and the side control information may be used to control operations or change configurations of the NCR 320. Specifically, the NCR-MT 322 demodulates and decodes side control information transmitted via the control link 342 which may be based on the Uu interface, so that the NCR may change its beamforming operations, adjust transmission and/or reception timings, set its Uplink-Downlink Time Division Duplexing (UL-DL TDD) configuration, turn on/off, and/or change its transmission power, etc. After the NCR-MT 322 decodes side control information, it may change operational parameters of the NCR 320, and/or it may control operations of the NCR-Fwd 324 based on the decoded information, for example, increasing or reducing the transmission power of the NCR-Fwd 324.

The side control information includes information used to control the NCR 320. It may include at least one of the following: beamforming information, timing information to align transmission/reception boundaries of the network-controlled repeater, information on UL-DL TDD configuration, ON-OFF information for efficient interference management and improved energy efficiency, and power control information for efficient interference management. The side control information may be included in L1 or L2 signaling to be transmitted to the NCR 320 from the gNB 310.

when the UE 330 and the gNB 310 communicate with each other, the NCR-Fwd 324 functions as a relay. Specifically, in the uplink direction, the NCR-Fwd 324 receives a UL message from the UE 330 via the access link 346, and after amplifying the UL message, it transmits the amplified UL message to the gNB 310 via the backhaul link 344. In the downlink direction, the NCR-Fwd 324 receives a DL message from the gNB 310 via the backhaul link 344, and after amplifying the DL message, it transmits the amplified DL message to the UE 330 via the access link 346. With use of the NCR-Fwd 324, the coverage of the gNB 310 may be extended, so that the UE 330 which may be out of the coverage is able to communicate with the gNB 310. During signal transmission and reception of the UE 330, the UE 330 may not know presence of the NCR 320.

As shown in FIG. 3, the control link 342 and backhaul link 344 are between the gNB 310 and the NCR 320. These two links may at least partially overlap in the frequency domain, so that the gNB 310 may perform inband control to the NCR 320. As described above, the gNB 310 may transmit side control information on the NCR 320 via the control link 342 to control its behaviors. Before the gNB 310 transmits the side control information, the NCR 320 is needed to be identified, and further, the NCR 320 may be needed to be authorized so as to operate under the control of the gNB 310. Signaling exchange for identification and authorization for the NCR 320 occurs in the control link 342. Hereinafter, how to identify the NCR will be described, and if the NCR is needed to be authorized so as to operate in the network, how to authorize it will also be described.

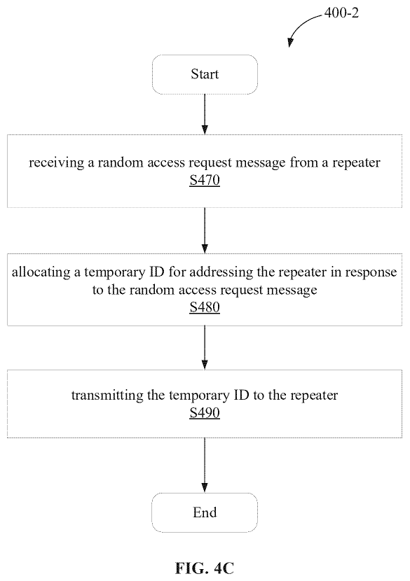

FIG. 4A illustrates a flow chart of a method 400 for identifying a repeater, according to embodiments disclosed herein. In FIG. 4A, a repeater 410 may be the same as the NCR 320 shown in FIG. 3, and a base station 420 may be the same as the base station shown in FIG. 3.

After the repeater 410 is powered on, the repeater 410 may transmit a random access request message to the base station 420 in step S410. According to some aspects, the repeater 410 may transmit the random access request message to the base station 420 through a preconfigured resource, such as a specific resource configured by the OAM. For example, a technical staff may set resource information indicating a special Random Access Channel (RACH) resource into the repeater 410 and the base station 420, so that the repeater 410 and the base station 420 can determine to use the set resource to perform random access. According to the special RACH resource used by the repeater, the base station can know from UL signaling that it is communicating with a repeater. According to some aspects, the repeater 410 may transmit the random access request message to the base station 420 through a resource designated by the base station for the repeater to access to a network. For example, the base station 420 can select a resource to be used as a resource for access, and the base station 420 can broadcast information about this resource so the repeater 410 covered by the base station 420 may determine to use the resource to transmit the random access request message. According to some aspects, a resource used by the repeater to transmit the random access request message may be not just one resource, but configured to be from a resource pool including multiple resources. The repeater may select one of those resources from this predetermined resource pool to transmit its random access request message. According to some aspects, the resource pool may be not only for a repeater to use, but shared with both the repeater and ordinary UEs which are not repeaters. Further, the random access request message may adopt a form of a RACH preamble of the RACH procedure, or it may use other forms as long as the base station 420 is able to know this is a random access request and it needs to prepare to allocate a temporary identifier (ID) for access.

In step S420, the base station 420 allocates a temporary ID in response to the random access request message and transmits the temporary ID to the repeater 410. According to some aspects, the allocation of the temporary ID in response to the random access request message indicates the random access request message is an input or a cause for the allocation and the temporary ID is the output or a result, which means the temporary ID may be allocated at once when the random access request message is received, or may be allocated after several signaling exchanges between the repeater and the base station which are triggered by reception of the random access request message. According to some aspects, in order to transmit the temporary ID to the repeater 410, the base station 420 may broadcast the temporary ID in its serving cell. For example, the temporary ID may be carried in a random access response message (e.g, in the form of T-C-RNTI, and then later be promoted to a formal NCR-specific RNTI as the contention is resolved). That is, the random access response message which may be broadcasted by the base station may include information about temporary ID of the repeater 410. The temporary ID may be similar to the Cell-Radio Network Temporary Identifier (C-RNTI), and since this ID corresponds to the repeater (NCR), we can call it as NCR-RNTI. The temporary ID of the repeater is local to the base station, which means the temporary ID is unique per base station. In order to improve usage efficiency, the temporary ID may be recycled by the base station, if the repeater having the temporary ID has been considered to be turned off or offline. With use of the temporary ID, the repeater is allowed to be addressed in the control link. For example, the base station can put the side control information in Downlink Control Information (DCI) scrambled with the temporary ID corresponding to the repeater.

The random access response message may adopt a form of the Random Access Response (RAR) of the RACH procedure. The temporary ID of the repeater 410 may be initially represented as the Temporary-Cell-Radio Network Temporary Identifier (T-C-RNTI) which scrambles the Cyclic Redundancy Check (CRC) portion in the RAR. Then, according to some aspects, the T-C-RNTI will become C-RNTI to finally represent the temporal ID of the repeater after several signaling transmissions (e.g, after contention resolution). Even though there are T-C-RNTI and C-RNTI, these two identifiers are the same, and each of them can be regarded as the temporary ID of the NCR. Persons skilled in the art can understand the random access response message can adopt other forms, such as a dedicated message carrying the temporary ID to respond to the random access request message.

According to some aspects, the base station can allocate another “temporary ID” different from the T-C-RNTI included in the random access response message to address this specific NCR after knowing its NCR type and further characteristics. According to some aspects, the base station can also initiate a procedure to change this temporary ID, e.g., with a reset command containing the new temporary ID.

According to some aspects, after the repeater 410 obtains the temporary ID, it can communicate with the base station 420 with this ID in uplink. For example, the repeater 410 may listen to the downlink control link between it and the base station 420 to receive side control information using the temporary ID. According to some aspects, the repeater 410 may perform additional steps to make sure the temporary ID received in step S420 can be used and/or to authorize the repeater 410 to enable it to communicate with the base station 420 with the temporary ID. The details will be described below.

Based on the above random access procedure provided in this disclosure, a repeater can be allocated with a temporary ID and can use this ID to communicate with its serving base station, so that the base station can correctly transmit control information to the repeater to control its behaviors.

FIG. 4B illustrates a flow chart of a method 400-1 performed by a repeater, according to embodiments disclosed herein. In step S450, the repeater transmits a random access request message to a base station. In step S460, the repeater receives a temporary ID for addressing the repeater from the base station, wherein the temporary ID is allocated by the base station in response to the random access request message. The details of the method 400-1 may be understood with reference to FIG. 4A, which are omitted for brevity.

FIG. 4C illustrates a flow chart of a method 400-2 performed by a base station, according to embodiments disclosed herein. In step S470, the base station receives a random access request message from a repeater. In step S480, the base station allocates a temporary ID for addressing the repeater in response to the random access request message. In step S490, the base station transmits the temporary ID to the repeater. The details of the method 400-2 may be understood with reference to FIG. 4A, which are omitted for brevity.

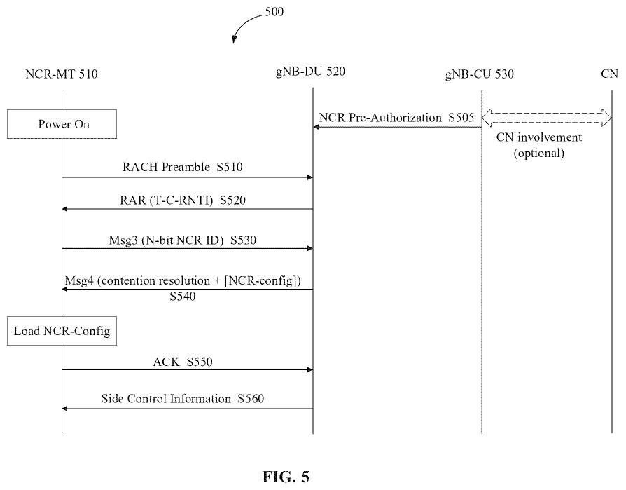

FIG. 5 illustrates a flow chart of another method 500 for identifying and authorizing a repeater, according to embodiments disclosed herein. In FIG. 5, for example, a base station such as the base station in FIG. 3 is a gNB which includes a distributed unit (DU) 520 and a centralized unit (CU) 530. The gNB-DU 520 communicates with an NCR-MT 510 included in an NCR such as the repeater in FIG. 3. In FIG. 5, the NCR is not only allocated with a temporary ID, but also authorized to make sure it is able to operate under the gNB control. A permanent ID of a repeater is introduced for the authorization.

In step S505, the gNB-CU 530 may perform a pre-authorization procedure with the gNB-DU 520. In this procedure, at least one authorizable ID may be input to the gNB-CU 530 for example by a technical staff or a network entity. The gNB-CU 530 may transmit the at least one authorizable ID to the gNB-DU 520 via for example an F1-C interface between them, so that the at least one authorizable ID is configured into the gNB-DU 520. Based on the at least one authorizable ID, the gNB-DU 520 can determine whether to authorize an NCR intended to access to it via the control link after it receives a permanent ID of the NCR from the NCR.

In step S510, the NCR-MT 510 transmits a RACH preamble through for example a resource preconfigured by the OAM to the gNB-DU 520 according to the RACH procedure, after the NCR-MT 510 is powered on.

In step S520, the gNB-DU 520 transmits a RAR carrying information about T-C-RNTI of the NCR to the NCR-MT 520.

In step S530, the NCR-MT 510 transmits Msg3 of the RACH procedure to the gNB-DU 520. The Msg3 may carry a permanent ID of the NCR, such us a N-bit NCR ID. The NCR ID may also be in MsgA. The Msg3 or MsgA carrying the NCR ID needs to be differentiated from the normal Msg3 or MsgA. It is preferrable that the permanent ID of the NCR does not overlap with a 40-bit random ID chosen by other UEs which is also carried by the Msg3 when a UE accesses to the network, so that the permanent ID of the NCR can be different from that of the UE. According to some aspects, the permanent ID of the NCR can be carried in MsgA, and it is also preferrable that it does not overlap with a 40-bit random ID chosen by other UEs which is also carried by the MsgA. This can be done by introducing an additional field in Msg 3 or Msg A to have a “type” field to indicate this message is from an NCR, not regular UEs. Instead of the MsgA/Msg3, the NCR-MT 510 may transmit a RRC message such as a RRC connection request message carrying the permanent ID to the gNB-DU 520. The permanent ID may differentiate each specific NCR, e.g,, among all the legitimated NCRs known to the network (NW) operator

According to some aspects, the permanent ID may share a same identification space with the UE, which means the NCR may be able to use a Subscriber Identity Module (SIM) like UE, or the NCR may be able to use an eSIM implemented in software, hardware, firmware or their arbitrary combination, so the NCR may include a subscription designated for it, and may have an identifier like Subscription Permanent Identifier (SUPI) and/or Temperate Mobile Station Identity (TMSI). By this way, the permanent ID also contain Public Land Mobile Network (PLMN) information. However, in order to differentiate the NCR from any UE, a flag bit (including at least one bit) indicating a device type is a repeater type rather than any UE type may be used in the permanent ID. In such a case, the permanent ID may include an ID corresponding to a SIM included in the repeater and a flag bit indicating a device type is a repeater type. according to some aspects, the flag bit may indicate the repeater is a special UE type.

According to some aspects, the permanent ID may be from a new independent identification space that is designated for the repeater type. For example, the permanent ID space dedicated to NCR usage may be solely managed by the network entity (for example, via OAM). This space is different from a UE ID space. An ID allocated from this space can be preconfigured into the NCR (e. g, when it is manufactured, commissioned, or deployed). As another example, the permanent ID may be a long-term NCR-specific RNTI that is unique to each repeater. For example, when an NCR is deployed, the long term NCR-specific RNTI is reserved in the corresponding base station when the OAM record is created in the base station site. When the NCR indicates this ID in the access signaling, the base station and NCR will switch from the temporary ID to use this reserved RNTI to communicate. Depending on how many NCRs are deployed in the cell, this reserved RNTI space can be small or large. If the NCR does not support an IP protocol stack, the permanent ID may be configured directly to the NCR, for example using AT commands.

According to some aspects, all NCRs in one cell or area served by a gNB may be allocated with a group identifier. The group identifier may be used to address all the NCRs served by the gNB, so it may be convenient for the gNB to control these NCRs with this group identifier, and thus improving control efficiency. According to some aspects, identifiers of an NCR may follow legacy usage of C-RNTI, I-RNTI and CN-identifier in different RRC states. According to some aspects, identifiers of an NCR may be persistently used in regardless of RRC state changes.

After the gNB-DU 520 receives the N-bit NCR ID which is a permanent ID of the NCR, the gNB-DU 520 determines whether the received permanent ID matches with one of the at least one authorizable ID received in the pre-authorization procedure. If yes, the gNB-DU 520 may determine to authorize the NCR so it can transmit side control information to the NCR. If not, the gNB-DU 520 may refuse the access of the NCR, thereby not providing any subsequent side control information to this device. Please be noted that even though the pre-authorization is performed in step S505, it can be performed in other timings as long as such pre-authorization happens before the gNB-DU determines whether to authorize the NCR.

If the gNB-DU 520 determines to authorize the NCR, then in step S540, the gNB-DU 520 transmits Msg4 of the RACH procedure to the NCR-MT 510. The Msg4 may include contention resolution. Based on reception of the contention resolution, the NCR-MT 510 may determine its random access is successful, and the T-C-RNTI received in step S520 becomes C-RNTI of the NCR, which can be used as the temporary ID of the NCR to communicate with the gNB. Thereafter, the NCR-MT 510 can use this temporary ID to receive side control information in a L1/L2 signaling from the gNB. As described above, each of T-C-RNTI and C-RNTI may be regarded as the temporary ID of the NCR. The difference between them is that one is initially allocated, and the other is a confirmed ID when random access is successful.

The Msg4 may further include repeater configuration information, which is also called as NCR-config herein. The NCR may load the NCR-config to determine its static configuration parameters, such as operational frequency bands, demodulation scheme, synchronization information, etc. If there is no NCR-config received from the gNB-DU 520, the NCR-MT 510 may load a default configuration. Please be noted that the NCR-config can be provided to the NCR-MT 510 in other messages, such as a message after the Msg4.

After finishing configuration based on the NCR-config or the default configuration, in step S550, the NCR-MT 510 may transmit an ACK to the gNB-DU 520 to indicate its configuration is finished. Step S550 is optional.

In step S560, the gNB-DU 520 transmits side control information in L1/L2 signaling. When the gNB-DU 520 transmits the L1/L2 signaling, the temporary ID of the NCR is used in the L1/L2 signaling to address the NCR.

For each NCR, the temporary ID such as C-RNTI or NCR-specific RNTI of the NCR is needed for L1 addressing, and NCR-specific side control information is coded with this L1 address. According to some aspects, once the temporary ID is allocated or assigned to the NCR, the NCR may keep using it constantly because the NCR will probably be stationary in the same cell and communicate with the same gNB for a very long time period. In such a case, the temporary ID of the NCR is not changed no matter how a RRC state of the NCR changes, and L1/L2 control and/or backhaul/access link will not be interrupted or influenced by RRC state changes. The gNB may maintain a simple NCR context, and L1/L2 side control information could be timely transmitted and received. The temporary ID may be used to scramble a specific portion such as a CRC portion in the signaling, or the temporary ID may be included in Medium Access Control (MAC) Control Element (CE). If the NCR needs to use the temporary ID to transmit information to the gNB via the control link, the temporary ID may be included in UL MAC CE.

According to some aspects, the temporary ID of the NCR may be updated in order to improve privacy and security. In such a case, the gNB may transmit repeater reset information to the NCR to ask the NCR to forget the current temporary ID and get a new temporary ID from the gNB. A message carrying the repeater reset information may be an NCR Reset message, which may be an OAM message or L2 MAC CE command. Even if the temporary ID remains unchanged in some cases, the NCR Reset message may still be supported, either in MAC CE or RRC.

In FIG. 5, the pre-authorization procedure is performed. However, this procedure may not be necessary. For example, any NCR deployed in a network may be assumed to be a certified equipment and shall be authorized automatically. If the pre-authorization procedure is needed, according to some aspects, the core network (CN) may be involved. For example, the authorizable IDs transmitted from the gNB-CU to the gNB-DU in step S505 may be obtained from the CN. However, the CN involvement may be optional. According to some aspects, if some security risk is identified and needs to be solved, SA3 may be involved.

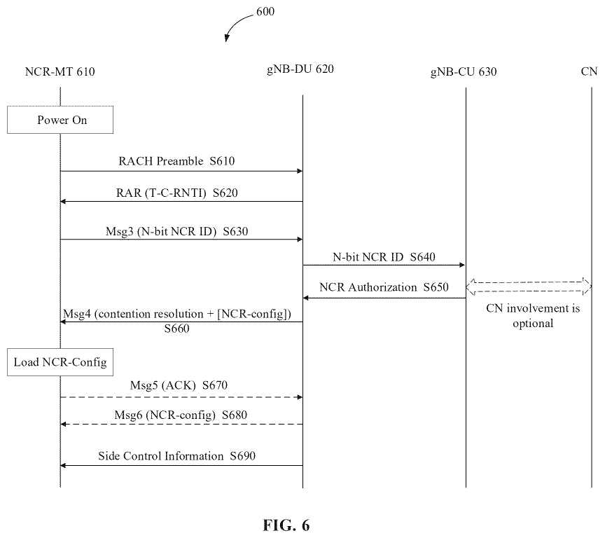

Instead of the pre-authorization procedure as shown in FIG. 5, the base station can perform an authorization procedure as shown in FIG. 6, which illustrates a flow chart of another method 600 for identifying and authorizing a repeater, according to embodiments disclosed herein. However, as described above, like the pre-authorization procedure, the authorization procedure as shown in FIG. 6 may also be not necessary. In the authorization procedure, the authorization may be done on-the-fly when NCR access signaling reaches the base station (such as the gNB, specifically the gNB-DU).

In FIG. 6, the NCR-MT 610 included in an NCR and gNB-DU 620 and gNB-CU 630 included in a gNB are substantially the same as the NCR-MT 510, gNB-DU 520, gNB-CU 530 shown in FIG. 5, respectively, but there is no pre-authorization procedure performed. Specifically, in FIG. 6, there is no step corresponding to the step S505, and steps S640 and S650 are performed for authenticating the NCR. In FIG. 6, Steps S610, S620 and S630 may be the same as the steps S510, S520 and S530.

After the gNB-DU 620 receives the permanent ID (i.e., N-bit NCR ID) of the NCR in step S630, in step S640, the gNB-DU 620 transmits the permanent ID to the gNB-CU 630, to cause the gNB-CU 630 to authorize the NCR based on the permanent ID according to a predetermined strategy. For example, the gNB-CU 630 may search out a preconfigured record corresponding to the permanent ID which includes NCR information stored in advance. If location information of the NCR is within the coverage of the gNB-DU 620, or capability information of the NCR matches with requirement of the gNB-DU 620, or the permanent ID information belongs to authorizable IDs, the gNB-CU 630 may determine to authorize the NCR.

According to some aspects, during the the authorization procedure, the CN may be involved. For example, the permanent ID transmitted from the gNB-DU to the gNB-CU in step S640 may be further transmitted to the CN to cause the CN to determine whether to authorize the NCR. As another example, the strategy or record used by the gNB-CU to determine whether to authorize the NCR may be obtained from the CN. However, CN involvement is optional.

According to some aspects, a gNB may authorize an NCR based on a coverage of the gNB. For example, the gNB will determine whether the NCR is on the border of a cell it serves for. If the NCR is on the border, e.g., if Reference Signal Receiving Power (RSRP) measurement of the NCR is low (e.g., below a predetermined threshold), the gNB may authorize the NCR. On the other hand, if the NCR's RSRP measurement is strong (e.g., above a predetermined threshold), the gNB may not authorize it. According to some aspects, a gNB may authorize an NCR based on location of the NCR. For example, the gNB may consider a density factor. If there is already an authorized NCR in the proximity of a new NCR intended to access, the gNB may not authorize the new NCR. As another example, the gNB may only allow the NCR to be used in a certain location it is designated to. According to some aspects, a gNB may authorize an NCR based on capability of the NCR. For example, different NCRs may have heterogeneous capability, such as different number of panels, different power-classes, etc. If an NCR has a capability higher than a predetermined requirement, the gNB may authorize it. Persons skilled in the art may conceive of other manners used by a gNB to authorize an NCR.

After the gNB-CU 630 determines to authorize the NCR, in step S650, the gNB-CU 630 transmits a repeater related message carrying authorization information to the gNB-DU 620, the authorization information indicating the gNB-DU to authorize the NCR. For example, the gNB-CU 630 may transmit an NCR context setup request message or a NCR context modification request message to the gNB-DU 620. The message may carry a special set of information elements (IEs) and parameters used to for example indicate the NCR can be authorized and/or how to configure the NCR. For example, a new IE like an NCR Services Authorized IE may be included in the message, to indicate the gNB-DU 620 to provide services to the NCR, and thus the NCR can operate under the control of the gNB-DU 620.

Once the gNB-DU 620 determines the NCR can be authorized according to authorization information of step S650, in step S660, the gNB-DU 620 transmits the Msg4 including contention resolution and NCR-config to the NCR-MT 610. Based on reception of the Msg4 by the NCR-MT 610, T-C-RNTI becomes C-RNTI which is used as the temporary ID of the NCR. Further, the NCR-MT 610 loads the NCR-config so as to communicate with the gNB-DU 620 to receive side control information. After finishing configuration, the NCR-MT 610 transmits an ACK to the gNB-DU in step S670. In some aspects, step S670 is optional. According to some aspects, the NCR-config can be transmitted from the gNB-DU 620 in another message, such as in a message in step S680. In some aspects, step S680 is also optional. In step S690, the gNB-DU 620 transmits side control information in L1/L2 to the NCR-MT 610 to control its operations.

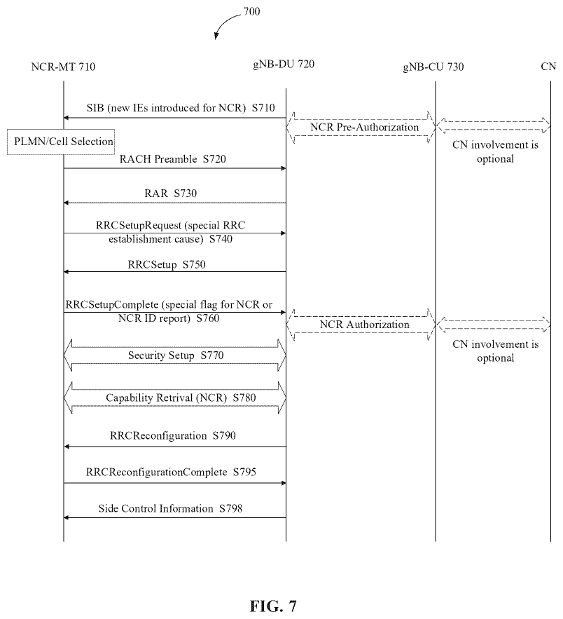

Besides the above approach to identify and authorize the NCR, the identification and authorization for the NCR may be implemented via RRC as shown in FIG. 7. FIG. 7 illustrates a flow chart of another method 700 for identifying and authorizing a repeater using RRC signaling, according to embodiments disclosed herein. NCR-MT 710 included in an NCR and gNB-DU 720 and gNB-CU 730 included in a gNB are substantially the same as the NCR-MT 510, gNB-DU 520, gNB-CU 530 shown in FIG. 5, respectively. The NCR in FIG. 7 needs a full stack support. Control link configuration via RRC needs to address NCR ID transmission and NCR capability reporting, which is shown below.

In step S710, the gNB-DU 720 broadcasts a system message such as a system information block (SIB) in a cell it serves for. The broadcasting operation may be performed periodically or in response to a schedule instruction from the gNB-CU 730 or the CN. The system message may carry new IEs introduced for the NCR in a newly designated SIB for NCR specific purpose. Alternatively, those new IEs can be still included in an existing SIB (e.g., SIB1). For example, the new IEs may indicate the gNB-DU 720 can support NCR so any NCR can access to this gNB-DU. The new IEs may include repeater configuration information to configure the NCR that can access to this gNB-DU. This repeater configuration information may be common to all the NCRs that can access to this gNB-DU, and it may indicate a resource that RACH preambles can be transmitted through.

After the NCR-MT 710 performs PLMN or cell selection, in step S720, the NCR-MT 710 transmits a RACH preamble to the gNB-DU 720 through a resource specific to the NCR.

In Step S730, the gNB-DU 720 Transmits the RAR carrying T-C-RNTI to the NCR-MT 710.

In step S740, the NCR-MT 710 transmits a RRC connection request message to the gNB-DU 720. The RRC connection request message may be RRCSetupRequest. It may be piggybacked by the Msg3 of the RACH procedure, or it may piggyback the Msg3. This message may carry information about the temporal ID of the NCR. Further, the RRC connection request message may carry information indicating a special RRC establishment cause, such as information indicating the requested RRC connection is between the NCR and the gNB. Based on the special RRC establishment cause, the gNB can be notified that the corresponding access is from an NCR rather than a UE, so that the gNB only needs to configure a control plane and does not need to configure a user plane, which will improve processing efficiency of the gNB.

In step S750, the gNB-DU 720 transmits a RRC connection setup message such as RRCSetup to the NCR-MT 710. This message may be piggybacked by the Msg4 of the RACH procedure, or it may piggyback the Msg4. This message may carry information about contention resolution, and it may further carry the “NCR-config” field to provide the NCR with configuration parameters to make it able to operate under the gNB control. Once the NCR-MT 710 obtains information about contention resolution, T-C-RNTI received in step S730 becomes C-RNTI to be used as the temporal ID of the NCR. According to some aspects, the temporal ID of the NCR may be not the same as C-RNTI which is based on T-C-RNTI. For example, the temporal ID may be carried in RRC signaling to be transmitted to the NCR after the NCR transmits a random access request message.

In step S760, the NCR-MT 710 transmits a RRC connection setup complete message such as RRCSetupComplete to the gNB-DU 720. This message may carry a special flag for NCR or NCR ID report, to provide the gNB-DU 720 with a permanent ID of the NCR. According to some aspects, the special flag for NCR or NCR ID report may be carried in the Msg3 or MsgA of the RACH procedure. In such a case, the temporal ID of the NCR may be carried in RRC signaling in the downlink. Based on the permanent ID, the gNB-DU 720 can determine whether to authorize the NCR according to the pre-authorization procedure described in FIG. 5 or the authorization procedure described in FIG. 6. In the pre-authorization procedure or the authorization procedure, the CN may be involved as described above.

In step S770, the NCR-MT 710 communicates with the gNB-DU 720 to perform security setup. This step may be optional.

In step S780, the NCR-MT 710 communicates with the gNB-DU 720 for capability retrieval. For example, the NCR-MT 710 may transmit its capability information to the gNB-DU 720, so that the gNB may determine side control information to be transmitted to the repeater based on the capability information. In some examples, based on communication of RRC signaling, the gNB can determine NCR capability such as how may beams it can receive, how much power it can use in a certain direction, etc. Based on the NCR capability, the gNB can determine how to configure or control the NCR.

In step S790, the gNB-DU 720 transmits a RRC Reconfiguration message such as RRCReconfiguration to the NCR-MT 710. For example, the gNB-DU 720 can reconfigure RRC connection based on the NCR capability.

In step S795, the NCR-MT 710 transmits a RRC Reconfiguration complete message such as RRCReconfiguration Complete to the gNB-DU 710, to confirm the RRC connection reconfiguration is finished.

In step S798, the gNB-DU 720 transmits side control information in a L1/L2 signaling to the NCR-MT 710. For example, the side control information can dynamically adjust the transmission power of the NCR.

Not all the steps in FIG. 7 need to be included in one embodiment. These steps can be flexibly chosen or combined as long as they can provide the temporal ID to the NCR, or as long as they can provide the temporal ID to the NCR while authorizing the NCR. Some steps can be omitted as needed, for example, steps S770, S780, S790 and S795 may be not necessary.

Embodiments contemplated herein include an apparatus comprising means to perform one or more elements of any of the methods 400-700. This apparatus may be, for example, an apparatus of a repeater or an apparatus of a base station (such as a repeater 202 and a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of any of the methods 400-700. This non-transitory computer-readable media may be, for example, a memory of a repeater or a memory of a base station (such as a memory 206 of a repeater 202 or a memory 222 of a network device 218 which is a base station, as described herein).

Embodiments contemplated herein include an apparatus comprising logic, modules, or circuitry to perform one or more elements of any of the methods 400-700. This apparatus may be, for example, an apparatus of a repeater or an apparatus of a base station (such as a repeater 202 and a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of any of the methods 400-700. This apparatus may be, for example, an apparatus of a repeater or an apparatus of a base station (such as a repeater 202 and a network device 218 that is a base station, as described herein).

Embodiments contemplated herein include a signal as described in or related to one or more elements of any of the methods 400-700.

Embodiments contemplated herein include a computer program or computer program product comprising instructions, wherein execution of the program by a processor is to cause the processor to carry out one or more elements of any of the methods 400-700. The processor may be a processor of a repeater (such as a processor(s) 204 of a repeater 202, as described herein). These instructions may be, for example, located in the processor and/or on a memory of the repeater (such as a memory 206 of a repeater 202, as described herein). Further, the processor may be a processor of a base station (such as a processor(s) 220 of a network device 218 that is a base station, as described herein). These instructions may be, for example, located in the processor and/or on a memory of the base station (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, repeater, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A repeater, comprising:
an antenna for performing wireless communications;
a radio coupled to the antenna; and
a processor coupled to the radio and configured to cause the repeater to:
transmit a random access request message to a base station; and
receive a temporary ID for addressing the repeater from the base station, wherein the temporary ID is allocated by the base station in response to the random access request message.

2. The repeater of claim 1, wherein the processor is further configured to cause the repeater to:
communicate with the base station using the temporary ID, wherein the temporary ID is network-controlled repeater (NCR) specific Radio Network Temporary Identifier (RNTI), NCR-RNTI.

3. The repeater of claim 2, wherein the processor is further configured to cause the repeater to:
receive side control information for controlling an operation of the repeater from the base station, wherein the side control information is received via downlink control information (DCI) and scrambled with the temporary ID.

4. The repeater of claim 3, wherein the processor is further configured to cause the repeater to, before receiving the side control information from the base station, transmit a permanent ID of the repeater to the base station, to cause a network side to authorize the repeater based on the permanent ID, wherein the permanent ID includes an ID corresponding to a SIM or subscription designated for the repeater.

5. The repeater of claim 4, wherein the processor is further configured to cause the repeater to, after receiving a random access response message from the base station, transmit the permanent ID of the repeater to the base station.

6. The repeater of claim 5, wherein the processor is further configured to cause the repeater to transmit the permanent ID of the repeater to the base station through a RACH Msg3 or a RRC setup complete (RRCSetupComplete) message.

7. The repeater of claim 1, wherein the processor is further configured to cause the repeater to send a RRC setup complete message including a flag indicating a device type as a network-controlled repeater (NCR) node.

8. The repeater of claim 4, wherein the permanent ID includes an ID from an identification space specific to a repeater type.

9. The repeater of claim 1, wherein the processor is further configured to cause the repeater to perform at least one of the following:
transmitting the random access request message to the base station through a preconfigured resource,
transmitting the random access request message to the base station through a resource designated by the base station for the repeater to access a network,
transmitting the random access request message to the base station through a resource selected from a resource pool designated for the repeater, or
transmitting the random access request message to the base station through a resource selected from a resource pool shared by the repeater and a user equipment.

10. The repeater of claim 1, wherein the processor is further configured to cause the repeater to receive a configuration message carrying repeater configuration information from the base station.

11. The repeater of claim 1, wherein the processor is further configured to cause the repeater to receive a system message carrying repeater support information broadcasted from the base station.

12. The repeater of claim 1, wherein the processor is further configured to cause the repeater to notify the base station of capability information of the repeater, to cause the base station to determine side control information to be transmitted to the repeater based on the capability information.

13. The repeater of claim 1, wherein the processor is further configured to cause the repeater to transmit a RRC connection request message that requests a RRC connection to the base station, wherein the RRC connection request message carries information indicating the RRC connection is between the repeater and the base station.

14. The repeater of claim 1, wherein the processor is further configured to cause the repeater to receive repeater reset information to update the temporary ID of the repeater.

15. The repeater of claim 1, wherein the processor is further configured to cause the repeater to receive a group identifier from the base station to address all repeaters served by the base station.

16. (canceled)

17. A method performed by a repeater, comprising:
transmitting a random access request message to a base station; and
receiving a temporary ID for addressing the repeater from the base station, wherein the temporary ID is allocated by the base station in response to the random access request message.

18. A base station, comprising:
an antenna for performing wireless communications;
a radio coupled to the antenna; and
a processor coupled to the radio and configured to cause the base station to:
receive a random access request message from a repeater;
allocate a temporary ID for addressing the repeater in response to the random access request message; and
transmit the temporary ID to the repeater.

19. The base station of claim 18, wherein the processor is further configured to cause the base station to:
transmit side control information to the repeater,
wherein the side control information is scrambled with the temporary ID, and
wherein the temporary ID is network-controlled repeater (NCR) specific Radio Network Temporary Identifier (RNTI), NCR-RNTI.

20. The base station of claim 19, wherein the processor is further configured to cause the base station to, before transmitting side control information to the repeater using the temporary ID, receive a permanent ID of the repeater from the repeater, to authorize the repeater based on the permanent ID.

21. The base station of claim 20, wherein the base station includes a CU and a DU, and at least one authorizable ID is configured in the DU by the CU, and
wherein the processor is further configured to cause the DU of the base station to:
when the permanent ID received from the repeater is determined to match with one of the at least one authorizable ID, determine to authorize the repeater.

22-29. (canceled)
